(19) United States
(12) Patent Application Publication
(10) Pub. No.: US 2011/0109026 A1
(43) Pub. Date: May 12, 2011

(54) Progressive shock absorbing line device

(76) Inventor: Eric Sanford, White Salmon, WA (US)

(21) Appl. No.: 12/590,453

(22) Filed: Nov. 6, 2009

(51) Int. Cl. F16F 9/00

(52) U.S. Cl. 267/140.13

(57) ABSTRACT

A shock absorbing line device preferably comprising at least two inner resilient components having different working lengths to provide progressive change in the tension developed by the device. The inner resilient components can be formed from one or more loops of shock cord. The use of an internal limiting member restricts the overall extension of the device.

### FIELD OF THE PRESENT INVENTION

The present invention relates generally devices for securing to objects together. More particularly, the invention relates to flexible devices for securing objects that are capable of absorbing forces tending to separate the objects.

### BACKGROUND ART

A common method for securing objects together comprises a simple line or rope. While this has the advantage of being flexible and adaptable, there are situations where such methods have undesirable characteristics.

For example, it is often advantageous to provide a device that is compliant or elastic. Such a device can provide tension between the two objects even when the distance between them changes. In contrast, a simple rope becomes slack once the distance between the objects decreases. Further, the use of an elastic device offers the ability to absorb force or shock as the objects are moved apart.

The lack of these features is often exacerbated when the objects being secured are able to move independently of each other. When a rope is used, it becomes slack as the objects move together and allows the objects to move apart without resistance until the slack is taken up, at which point it becomes taut and rapidly transmits force and shock to the objects. When sufficient forces are involved, this can result in substantial jarring.

Attempts to address these deficiencies include the use of elastic line. However, tying knots in elastic line can be difficult. Further, elastic lines often exhibit reduced breaking strength as compared to non-elastic lines.

One prior art improvement on a simple rope is the bungee cord. Such devices typically comprise an elastic cord having hooks at either end. While convenient, bungee cords have their own deficiencies. For example, the hooks typically offer a secure means of attachment only when there is tension applied to the cord. Once the cord becomes slack, it is relatively easy for the hook to become disengaged. Further, typical bungee cords are not often built to handle significant stresses. As users of such devices are aware, the elastic cord often fails and the hooks deform.

In other situations, it would be advantageous to a device that allows varying levels of tension depending upon the extension of the device. For example, when securing a boat, it may be desirable to provide a device should that exhibits less tension at low degrees of extension but offer an increasing amount of tension as the device is extended further. Thus, relatively small forces would experience a less amount of tension to smoothly take up shock while greater forces would experience a greater amount to adequately control motion.

Thus, what has been needed is a device to reliably secure objects together. There is also a need for such a device that is flexible and can absorb shock or maintain tension between the secured objects. There is also a need for a device that exhibits varying degrees of tension depending upon the overall extension of the device. This invention satisfies these and other needs.

### SUMMARY OF THE INVENTION

In accordance with the above objects and those that will be mentioned and will become apparent below, the invention is a shock absorbing line device comprising a first inner resilient component and a second inner resilient component, each having opposing ends, wherein the first inner resilient component has a first length and the second inner resilient component has a second length that is greater than the first length, and attachment devices secured to the opposing ends. Preferably, the first or second inner resilient component comprises at least one loop of shock cord.

In one aspect, the first inner resilient component comprises a plurality of loops of shock cord and the second inner resilient component comprises at least one loop of shock cord. Alternatively, the second inner resilient component comprises a plurality of loops of shock cord and the first inner resilient component comprises at least one loop of shock cord.

In one embodiment, the device also includes a flexible protector covering one or more portions of the inner resilient components.

In use, extension of the device over a first distance causes the first inner resilient component to stretch and extension of the device over an additional distance causes the second inner resilient component to stretch and the device exhibits a first tension when extended in a range corresponding to the first distance and a second tension that is greater than the first tension when extended in a range corresponding to the second distance.

Another aspect of the invention includes an internal limiting member, wherein the internal limiting member is secured to the attachment devices and the opposing ends of the first and second inner resilient components are attached to the internal limiting member and wherein the internal limiting member has a length that is greater than the second length of the second inner resilient component. Preferably, one opposing end of the first and second inner resilient components are attached to the internal limiting member at a first location, one opposing end of the second inner resilient component is attached to the internal limiting member at a second location and one opposing end of the first inner resilient component is attached to the internal limiting member at an intermediate location between the first location and the second location. Also preferably, the distance between the first location and the intermediate location on the internal limiting member is greater than the length of the first inner resilient component and the distance between the first location and the second location on the internal limiting member is greater than the length of the second inner resilient component.

In use, extension of the device over a first distance corresponding to the distance between the intermediate location and the second location on the internal limiting member causes the second inner resilient component to stretch and wherein further extension of the device causes the first inner resilient component to stretch, so that the device exhibits a first tension when extended in a range corresponding to the first distance and a second tension that is greater than the first tension when extended in a range greater than the first distance.

In another aspect, the device also includes at least one additional inner resilient component having a third length that is greater than the second length of the second inner resilient component.

The invention also includes a method for reducing shock between a first and second object comprising the steps of providing a shock absorbing line device comprising a first inner resilient component and a second inner resilient component, each having opposing ends, wherein the first inner resilient component has a first length and the second inner resilient component has a second length that is greater than the first length, and attachment devices secured to the opposing ends, and securing a first end of the shock absorbing line device to the first object and a second end of the shock absorbing line device to the second object, so that the amount of shock transmitted to the first and second object when they are moved away from each other is reduced.

In another aspect, the method includes providing a shock absorbing line device that also has an internal limiting member, wherein the internal limiting member is secured to the attachment devices and the opposing ends of the first and second inner resilient components are attached to the internal limiting member and wherein the internal limiting member has a length that is greater than the second length of the second inner resilient component.

### BRIEF DESCRIPTION OF THE DRAWINGS

FIG. 1 is a schematic view showing internal components of a shock-absorbing line device of the invention;

FIG. 2 is schematic view of an alternate embodiment of the invention featuring an internal limiting member;

FIG. 3 is a schematic view of another embodiment of the invention featuring a sail boat having a shock-absorbing line device of the invention;

FIG. 4 is an overall view of a shock absorbing line device having a flexible protector.

### DETAILED DESCRIPTION OF THE INVENTION

It is to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise.

Earlier U.S. Pat. No. 7,032,529 to Sanford discloses a shock absorbing line device and provides details on examples of suitable materials and construction, but does not feature progressive variation in tension. The disclosure of this patent is hereby incorporated by reference in its entirety.

This invention comprises a device for attaching two objects together. The device is a flexible member that has shock absorbing qualities and offers varying tension at different degrees of extension of the device. The invention generally comprises at least two inner resilient components having opposing ends to which attachment devices can be secured. The inner resilient component may have a flexible protector covering one or more portions of the inner resilient component. In some embodiments, the invention further comprises an internal limiting member secured to the attachment devices.

In a preferred embodiment, the inner resilient components comprise one or more loops of shock cord, the attachment devices comprise carabiners or other clips and the flexible protector comprises tubular webbing. Specifically, a proper length of shock cord is determined by measuring the final desired length of the product and adding sufficient length to allow for securing the ends of the shock cord. For example, when a knot is used to secure the ends of the shock cord, twelve inches is generally suitable to allow for knotting and excess ends. In embodiments comprising an internal limiting member, the limit member controls the overall extension of the device.

Currently preferred lengths of the shock absorbing line device are twelve inches, eighteen inches and twenty-four inches. However, one will recognize that any suitable length can be used. In general, the greater the length of the device, the greater the amount of shock absorbing travel.

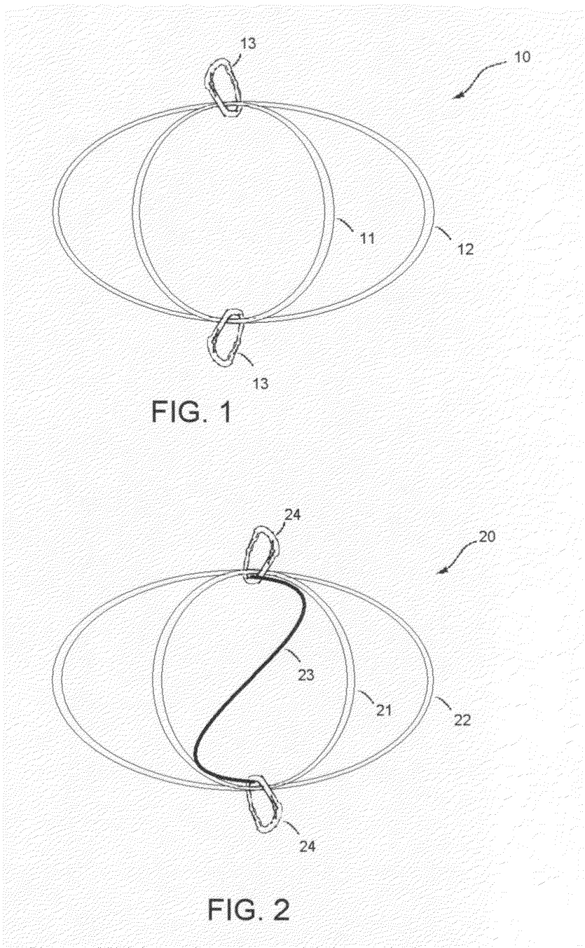

Turning now to FIG. 1, shock absorbing line device 10 is shown schematically. First inner resilient component 11 and second inner resilient component 12 are secured attachment devices 13 by being looped through them. As shown, first inner resilient component 11 has a length shorter than second inner resilient component 12. Accordingly, as attachment devices 13 are moved apart from each other, first inner resilient component 11 begins to stretch once the overall extension of the device is greater than the resting length of first inner resilient component 11. As the attachment device continue to be moved away from each other, the overall extension of the device reaches the length of second inner resilient component 12. Thus, further extension of device 10 causes second inner resilient component 12 to stretch along with the further stretching of inner resilient component 11.

As will be appreciated, device 10 generally exhibits a first tension corresponding to the stretching of inner resilient component 11 in the range of extension that is greater than the length of first inner resilient component 11, but shorter than the length of second inner resilient component 12. Similarly, device 10 generally exhibits a second tension corresponding to the stretching of inner resilient component 11 in the range of extension that is greater than the length of second inner resilient component 12.

Depending upon the choice of material for the inner resilient components, each tension experienced within the different extension ranges may not be exactly uniform due to non-linearity in the curve of elasticity. However, it should be appreciated that there will be a discontinuous change in the tension developed by device 10 at the switch between one inner resilient component being stretched and two inner resilient components being stretched.

In FIG. 2, another embodiment of the invention is shown, also schematically. Here, shock absorbing line device 20 has a first inner resilient component 21, a second inner resilient component 22 and an internal limiting member 23. Each has opposing ends which are secured to attachment devices 24. In the embodiment shown, the inner resilient components are looped through attachment devices 24, while internal limiting member 23 is secured by a knot, a sewn loop, or other suitable means. However, the inner resilient component can also be secured to the attachment devices via the internal limiting member. In other words, an end of the inner resilient component could be attached to the internal limiting member, which is then secured to the attachment device 24.

Although not drawn to scale, the resting, or untensioned, length of first inner resilient component 21 is less than the resting length of second inner resilient component 22, which is less than the length of internal limiting member 23. As such, extension of the device when attachment devices 24 are moved away from each other first causes first inner resilient component 21 to stretch until its length equals that of the second inner resilient component 22. Further extension of device 20 causes both first and second inner resilient components 21 and 22 to stretch until their length equals that of internal limiting member 23. Since internal limiting member 23 is preferably substantially inelastic, it limits the overall extension of device 20.

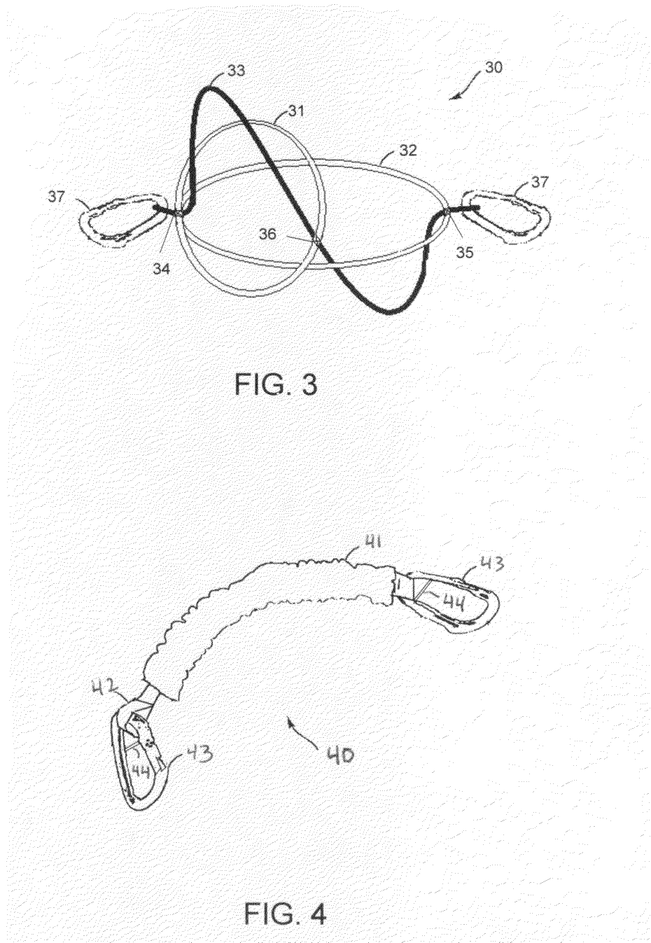

Yet another embodiment of the invention is shown in FIG. 3. Shock absorbing line device 30 includes first inner resilient component 31, second inner resilient component 32 and internal limiting member 33. First and second inner resilient components 31 and 32 are attached at a first location 34 on internal limiting member 33. Second inner resilient component 32 is attached at its other end to a second location 35 on internal limiting member 33. First inner resilient component 31 is attached at its other end to internal limiting member 33 at an intermediate location 36. Finally, the opposing ends of internal limiting member 33 are secured to attachment devices 37. The attachments can be sewn, a knot, a mechanical fastener such as a hog ring, or any other suitable means.

In operation, device 30 extends in a range from the length of the second inner resilient component 32 to the length of the first inner resilient component 31 plus the distance between the intermediate location 36 and the second location 35. Over that first range, substantially only the second inner resilient component 32 stretches, creating a tension between attachment devices 37 corresponding to its characteristics. At the end of this range, the internal limiting member 33 is taut between intermediate location 36 and second location 35. Further extension of device 30 now causes first inner resilient component 31 to stretch. In this range of extension, the tension between attachment devices 37 corresponds to both first and second inner resilient components 31 and 32. Extension of device 30 continues until internal limiting member 33 is taut between first location 34 and intermediate location 36. Thus, the overall length of internal limiting member 33 governs the working length of device 30.

FIG. 4 shows shock absorbing line device 40 of the invention featuring a further aspect, flexible protector 41, which comprises, for example, tubular webbing. As shown flexible protector 41 covers the majority of the inner resilient components, preventing damage or tangling, while keeping the device 40 essentially linear. In this embodiment, internal limiting member 42 is secured at either end to attachment devices 43. In this embodiment, attachment devices 43 are captive to internal limiting member 42, for example using clips 44 or other suitable means. As will be appreciated, this prevents attachment devices 43 from becoming accidentally detached from device 40 when opened for being secured to a desired object.

In the embodiments shown, the inner resilient components comprise a loop of elastic material. Changes in the tension characteristics of the device can easily be made by constructing one or both of the inner resilient members out of multiple loops of elastic material. Furthermore, a third or even more different length inner resilient members can also be employed to create additional variations in the tension developed by the device. These additional embodiments can be implemented with or without an internal limiting member. If using an internal limiting member, the inner resilient components can be attached at opposing ends, similar to the embodiment shown in FIG. 2, or at sequential locations along the internal limiting member corresponding to their length, similar to the embodiment shown in FIG. 3.

Currently preferred materials include shock cord material for the inner resilient components and nylon webbing for the internal limiting member. Tubular nylon webbing can be used for the flexible protector. Preferably, the shock cord is wrapped with approximately two wraps of adhesive tape at the cutting point so that the outer covering will not fray when cut. Shock cord is then cut with a razor knife or other suitable means. The ends are then connected by any suitable means. Nylon webbing and similar materials are preferably cut and ends melted to prevent fraying, such as by heat cutting.

As described above, one means of attaching the shock cord ends comprise knotting, using, for example a “grapevine knot” or “fisherman's bend” whereby one end forms an overhand knot, the other end is drawn through the resulting opening in this knot going in the opposite direction and tied into a duplicate overhand knot around the first shock cord end, preferably leaving one inch of loose end protruding on either side of the finished knot. Preferred knots become more secure when pressure is applied to each end of the device. The ends of the knot are grabbed with pliers and pulled until the knot is “set” and the resulting knot is of a diameter not greater than three times the diameter of a single strand of shock cord. Other preferred means of attachment include the use of stainless “hog rings” which are crimped so that the ends will not slip. Yet other means of attachment include adhesives and sewing, such as bar tacking.

Suitable attachment devices comprise carabiners, shackles, hooks and any other device capable of being releasably secured to fixed or mobile objects. As discussed above, the attachment devices can be made captive to the shock absorbing line device to prevent loss.

The length of the tubular webbing allows the internal shock cord to remain covered with protective tubular webbing even when fully stretched. One end may be fastened to a static object and the other end stretched until the length of the product is twice its unstretched length, then slowly released so that the tubular webbing cover is evenly distributed in a gathered position over the internal shock cord.

In one embodiment, materials include 5/16 inch nylon coated shock cord used as a stretchable internal member which will stretch to twice its original length. Two inch tubular nylon webbing used as a protective covering over the main body of the shock cord assembly and one inch tubular nylon webbing used as the internal limiting member. A 5/16 inch 16 gauge stainless steel hog ring is used to secure the ends of the shock cord, keeping the ends secure so that they will not untie from the knot used to secure them. Adhesive tape is wrapped around the ends of the shock cord to keep the outer nylon covering from unraveling. Aluminum 3⅜ inch I.D. D shaped carabiners, anodized to protect them from salt water corrosion, with a breaking strength of 5,000#, can be placed on each end. Using these materials as described above will result in a shock absorbing line device capable of at least 1200 pounds breaking strength.

As one of skill in the art will recognize, these materials may be easily substituted to tailor the characteristics of the shock absorbing line device. For example, greater diameter or less diameter shock cord can be used to tailor the strength and shock absorbing qualities. Also, more than one loop of shock cord could also be used to increase the resilience and strength of the device. Increasing the number of loops allows control over the shock absorbing line device's characteristics.

A presently preferred use for the shock absorbing line device of the invention is on the preventer of a sailboat. The crossover of the boom is traditionally initiated by a rudder controlled change in the sailing direction of the boat, and by hauling and subsequent releasing of the sheeting arrangement to force the boom over the centerline of the boat. Depending on the boat and the conditions, the crossover of the boom can be very sudden and violent, especially because dangerous boom velocities may be reached around the centerline when jibing in strong winds or rough sea conditions. Thus, unintentional jibes pose an obvious hazard to the sailors and the boat itself. A well known preventer system comprises a fixed line arrangement attached to the boom, and which runs forward to a safe attachment point on the boat, so that the boom is kept fixed at that perpendicular position in question. Although a conventional preventer can help avoid the dangers of boom movement during unintentional jibes, it is unsatisfactory in a number of ways.

Primarily, once the slack in the preventer is taken up, all the energy represented by the movement of the boom is suddenly translated to the preventer and therefore to the boat. Over time bolts, cleats, shackles, lines, blocks, chain and pulleys can weaken and break due to continuous shock loading while in use. The shock absorbing line device of the invention can prevent these results. It also greatly quiets the system.

The shock absorbing line device of the invention is suitable for use in any situation where it is desirable to secure objects to one another, while maintaining tension or providing shock absorption.

For example, uses on a boat include securing the boom to the boat at rest for reducing noise and for allowing the mainsheet to be loosened to relieve stress on the sheet and boom. The shock absorbing line device can be used between a tow line and a dinghy to prevent the line from snapping taut to reduce the stress on the cleat, tow line and dinghy. Stress on the anchor and boat can be prevented and noise reduced by rigging a shock absorbing line device on the anchor chain. The device can also be used on the mooring line, the spinnaker tack, the tiller lash, the jibsheet rigging to obtain the same advantages in stress and noise reduction and sail trim.

In another application, the shock absorbing line device can be dimensioned to restrain and allow convenient use of a power hand tool, such as a rechargeable drill. By securing one end of the shock absorbing line device to the tool and the other end to the user, the tool can be used as normal. However, if the tool is dropped, the shock absorbing line device prevents it from striking the ground to protect it from damage.

Yet another application of the shock absorbing line device is for restraining a pet. By attaching the one end of the shock absorbing line device to a pet's collar and the other to a fixed object, the pet is controlled and any risk of injury is reduced by the shock absorbing qualities of the invention. Such embodiments can further comprise a handle at one end to allow convenient use as a leash, as well.

In general, the device of the invention can be used:

As a shock absorbing element whenever a static and movable object are attached to each other.

As a shock absorbing element whenever two movable objects are attached to each other.

As a shock absorbing element between two boats.

As a shock absorbing element between two cars.

As a shock absorbing element which is attached to the center portion of a rope, chain or cable so that a length of the rope, chain or cable is fixed between the carabiners is greater than the length of the line device.

As a shock absorbing element between the boom on a sailboat and a line which is rigged forward on the boat to prevent the boom from accidentally swinging in a large arc.

As a shock absorbing element rigged from the boom of a sailboat in order to fasten the boom end to the deck of the boat so that it will not swing freely.

As a shock absorbing element rigged on the side of a sailboat to which a line attaching a sail is lead so that there is no static load placed on the line, sail or attaching point on the boat.

As a shock absorbing element between the wings or fuselage of an airplane and any static point on the ground to which the airplane is attached.

As a shock absorbing element rigged between an anchor and anchor chain.

As a shock absorbing element between a boat and dockline.

As a shock absorbing element which is attached to one corner of a sail so that the shock of a strong wind load into the sail will not stress the seams, grommets or tie-down connection to the lines or deck of a boat.

The shock absorbing line device of the invention can be made to any length and is flexible so can go over and around corners and edges. The outer flexible protector covers the inner resilient component affording abrasion and ultraviolet resistance. Outer flexible covering can be removed to inspect the integrity of the internal resilient component. Aluminum carabiners provide lightweight yet very strong attachment, but other releasable removable attachment means are also suitable. Preferably, the carabiners or attachment devices allow attachment of the product in a secure fashion so that it will not accidentally detach when pressure is removed.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

What is claimed is:

1. A shock absorbing line device comprising a first inner resilient component and a second inner resilient component, each having opposing ends, wherein the first inner resilient component has a first length and the second inner resilient component has a second length that is greater than the first length, and attachment devices secured to the opposing ends.

2. The line device of claim 1, wherein the first or second inner resilient component comprises at least one loop of shock cord.

3. The line device of claim 2, wherein the first inner resilient component comprises a plurality of loops of shock cord and the second inner resilient component comprises at least one loop of shock cord.

4. The line device of claim 2, wherein the second inner resilient component comprises a plurality of loops of shock cord and the first inner resilient component comprises at least one loop of shock cord.

5. The line device of claim 1, further comprising a flexible protector covering one or more portions of the inner resilient components.

6. The line device of claim 1, further comprising an internal limiting member, wherein the internal limiting member is secured to the attachment devices and the opposing ends of the first and second inner resilient components are attached to the internal limiting member and wherein the internal limiting member has a length that is greater than the second length of the second inner resilient component.

7. The line device of claim 6, wherein one opposing end of the first and second inner resilient components are attached to the internal limiting member at a first location, one opposing end of the second inner resilient component is attached to the internal limiting member at a second location and one opposing end of the first inner resilient component is attached to the internal limiting member at an intermediate location between the first location and the second location.

8. The line device of claim 7, wherein the distance between the first location and the intermediate location on the internal limiting member is greater than the length of the first inner resilient component and the distance between the first location and the second location on the internal limiting member is greater than the length of the second inner resilient component.

9. The line device of claim 1, further comprising at least one additional inner resilient component having a third length that is greater than the second length of the second inner resilient component.

10. The line device of claim 1, wherein extension of the device over a first distance causes the first inner resilient component to stretch and extension of the device over an additional distance causes the second inner resilient component to stretch and the device exhibits a first tension when extended in a range corresponding to the first distance and a second tension that is greater than the first tension when extended in a range corresponding to the second distance.

11. The line device of claim 8, wherein extension of the device over a first distance corresponding to the distance between the intermediate location and the second location on the internal limiting member causes the second inner resilient component to stretch and wherein further extension of the device causes the first inner resilient component to stretch, so that the device exhibits a first tension when extended in a range corresponding to the first distance and a second tension that is greater than the first tension when extended in a range greater than the first distance.

12. The line device of claim 1, wherein the attachment devices are captive.

13. A method for reducing shock between a first and second object comprising the steps of:
providing a shock absorbing line device comprising a first inner resilient component and a second inner resilient component, each having opposing ends, wherein the first inner resilient component has a first length and the second inner resilient component has a second length that is greater than the first length, and attachment devices secured to the opposing ends; and
securing a first end of the shock absorbing line device to the first object and a second end of the shock absorbing line device to the second object;
so that the amount of shock transmitted to the first and second object when they are moved away from each other is reduced.

14. The method of claim 13, wherein the step of providing a shock absorbing line device comprises providing a shock absorbing line device that further comprises an internal limiting member, wherein the internal limiting member is secured to the attachment devices and the opposing ends of the first and second inner resilient components are attached to the internal limiting member and wherein the internal limiting member has a length that is greater than the second length of the second inner resilient component.
